(19) United States
(12) Patent Application Publication
(10) Pub. No.: US 2007/0112618 A1
(43) Pub. Date: May 17, 2007

(54) Systems and methods for automatic generation of information

(75) Inventor: Milorad Krneta, Toronto (CA)

Correspondence Address: BIRCH STEWART KOLASCH & BIRCH, PO BOX 747, FALLS CHURCH, VA, 22040-0747, US

(73) Assignee: Generation 5 Mathematical technologies Inc., Toronto (CA)

(21) Appl. No.: 11/594,147

(22) Filed: Nov. 8, 2006

Related U.S. Application Data
(60) Provisional application No. 60/734,724, filed on Nov. 9, 2005.

(51) Int. Cl. G06F 17/30

(52) U.S. Cl. 705/10

(57) ABSTRACT

Methods and systems consistent with the principles of some embodiments of the present invention provide for determining a set of variables that together have strong predictive power relative to some target variable(s); identifying a subset of variables that together describe the majority of the information in the database; statistically segmenting the database; predicting unknown values in the target variables; combining prediction and VIVa; filling gaps in databases for further analysis or database completion; predicting probabilities; and outputting information based on the processed data. The outputs may relate to optimizing price to maximize return, producing a database based on postal code, identifying a trade area for sale of goods; and/or optimizing the distribution of marketing funds across various marketing channels.

### RELATED APPLICATION DATA

This application is related to and claims priority to U.S. Provisional Application No. 60/734,724, filed Nov. 9, 2005, entitled “Systems and Methods for Automatic Generation of Information”, which is expressly incorporated herein by reference in its entirety.

### BACKGROUND OF THE INVENTION

1. Field of the Invention

The present invention relates generally to systems and methods for automatically generating information.

2. Description of Related Art

Data mining is the process of extracting information from large volumes of data. This process is a computationally intensive exercise. It can be difficult to achieve even small performance improvements simply by tweaking known data mining algorithms. Sampling the input data may help, but this may result in reduced accuracy, which may be unacceptable for many tasks. Increasing the power of hardware does not offer much help as central processing unit (CPU) clock frequencies and hard drive data transfer rates have upper boundaries that cannot be overcome.

It is possible to increase the number of CPUs by providing multithreaded processor cores, multicore chips and multiprocessor servers to provide better performance. However the cost for providing such a system is very high. As such, there is a need for a system that can extract information from large volumes of data quickly and accurately.

### SUMMARY OF THE INVENTION

Systems and methods consistent with some embodiments of the present invention provide for optimizing price of a good to maximize returns from sales, including receiving user specifications and automatically generating a file containing descriptions of a plurality of scenarios covering at least one price supplied by the user; for each scenario and price, estimating sales on the basis of patterns in observed cases; searching for an optimal price by one of 1)inspections of all scenarios, 2) by a random search on a sample of scenarios, 3) by numerical optimization of a price function; and 4) a combination of a random preliminary search followed by numerical optimization; and providing the optimal price based on the search.

Alternatively, systems and methods consistent with some embodiments of the present invention provide for determining consumer trade areas including receiving information related to an acceptable percentage of relative expenditures; determining a plurality of zip codes for a store and order the plurality of zip codes by distance; determining total consumption for the store; calculating relative sums of expenditures for each of the plurality of zip codes; generating a convex hull including the relative sums of expenditures based on the received information relating to the acceptable percentage of relative expenditures; and designating a consumer trade area based on the generated convex hull.

Alternatively, systems and methods consistent with some embodiments of the present invention provide for optimizing the distribution of marketing funds across various marketing channels, including accessing a dataset including information related to at least one of product or category sales, general predictors, and marketing mix variables; receiving analytical options relating to at least one of total marketing budget constraints, total or incremental return on investment constraints, and marketing mix variables to be tested; generating sales predictions for every marketing mix; and reporting the generated sales predictions.

Alternatively, systems and methods consistent with some embodiments of the present invention provide for load balancing a plurality of queries, including receiving a query for processing at a load balancing module; identifying one of a plurality of servers capable of processing the received query by analyzing a queue of pending queries each of the plurality of servers; sending the received query to the identified server for processing; determining that the received query was processed; and reporting the results of the processed query. Alternatively, systems and methods consistent with some embodiments of the present invention provide for producing a database based on postal code, comprising creating a geographical linkage representing a connection between granular level units and aggregated level units; creating a historical cases dataset and anchor variables on target cases; and producing a database by using the geographical linkage and historical cases dataset to predict a target dataset.

### BRIEF DESCRIPTION OF THE DRAWINGS

The accompanying drawings, which are incorporated in and constitute a part of this specification, illustrate several embodiments of the invention and together with the description, serve to explain the principles of the invention, and, together with the description, explain the features and aspects of the invention. In the drawings,

FIG. 1A is an exemplary diagram of a system environment in which systems and methods, consistent with the principles of some embodiments of the present invention, may be implemented;

FIG. 1B is an exemplary diagram of modules included in the environment depicted in FIG. 1A, consistent with the principles of some embodiments of the present invention;

FIG. 2 is an exemplary diagram of the MWM module, consistent with the principles of some embodiments of the present invention;

FIG. 3 is an exemplary flow diagram of the steps performed by the price optimization module, consistent with some embodiments of the present invention;

FIG. 4A is an exemplary diagram of the components of the automatic trade area module, consistent with some embodiments of the present invention;

FIG. 4B is an exemplary flow diagram of the steps performed by the automatic trade area module, consistent with some embodiments of the present invention;

FIG. 5 is an exemplary diagram depicting modules included in the high performance parallel query engine and exemplary steps performed by each of the modules included in the high performance parallel query engine, consistent with some embodiments of the present invention; and

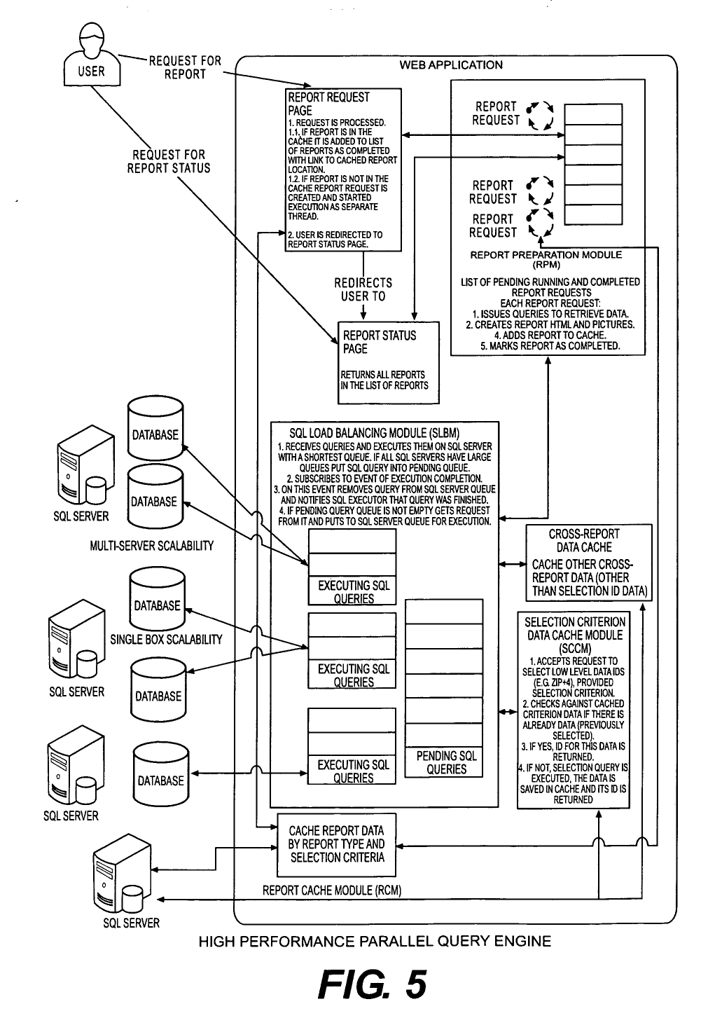

FIG. 6 is an exemplary flow diagram of the steps performed by the marketing mix module, consistent with some embodiments of the present invention.

### DETAILED DESCRIPTION

Reference will now be made in detail to the present invention, examples of which are illustrated in the accompanying drawings. Wherever possible, the same reference numbers will be used throughout the drawings to refer to the same or like parts.

Overview

Methods and systems consistent with the principles of some embodiments of the present invention provide for determining a set of variables that together have strong predictive power relative to some target variable(s) (VIVa module); identifying a subset of variables that together describe the majority of the information in the database (redundancy module); statistically segmenting the database (Clustering module); predicting unknown values in the target variables (Prediction module); combining prediction and VIVa; filling gaps in databases for further analysis or database completion; predicting probabilities; and outputting information based on the processed data. The outputs may relate to optimizing price to maximize return, producing a database based on postal code, identifying a trade area for sale of goods; and/or optimizing the distribution of marketing funds across various marketing channels.

System Architecture

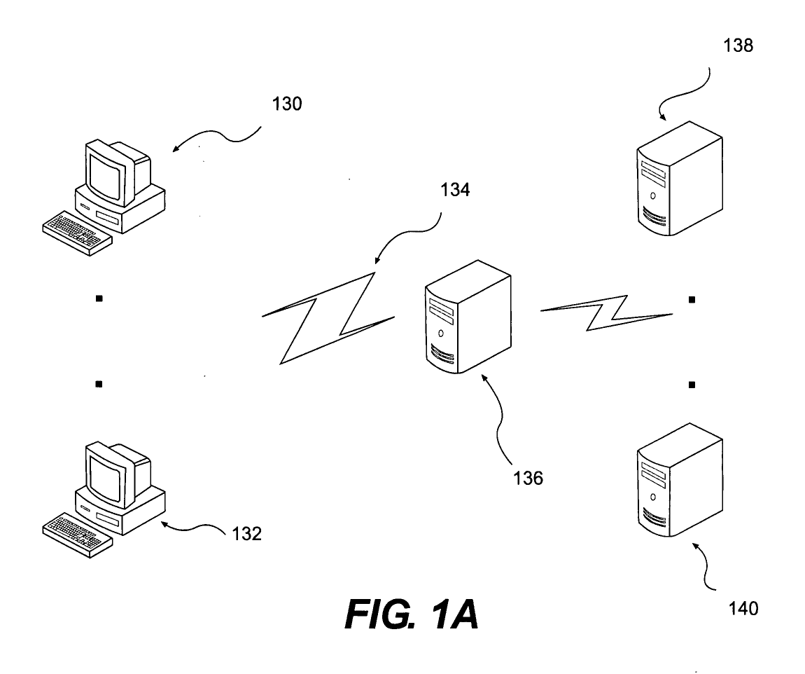

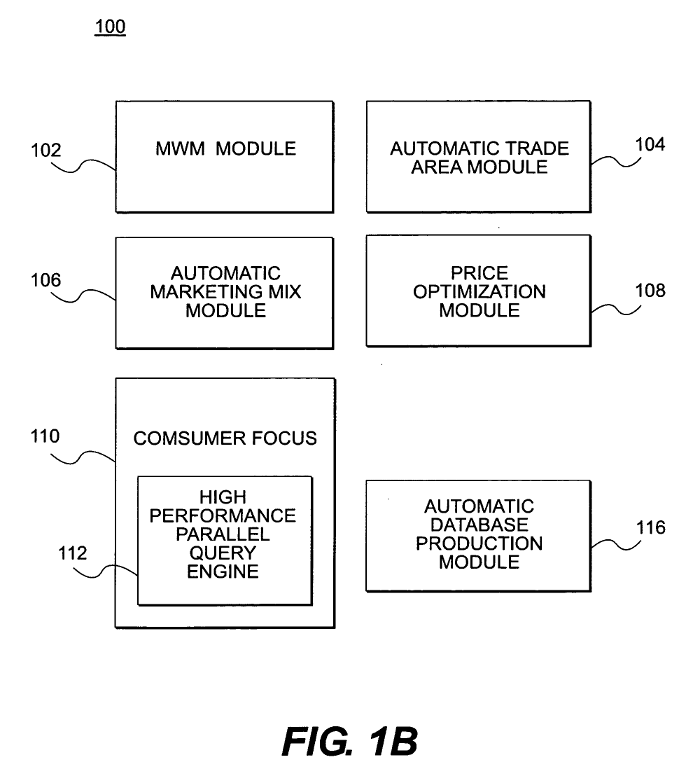

FIG. 1A is an exemplary diagram of a system environment for implementing principles consistent with some embodiments of the present invention. As depicted in FIG. 1A, computers 130 and 132 are depicted. Personal computers 130 and 132 may be implemented as known personal computing devices that include memory, a central processing unit, input/output devices and application software that enable the personal computers to communicably link to server 136 through communication link 134. Communication link 134 may be implemented as a wide area network, either public or private, a local area network, etc. Server 136 may be implemented using conventional components including memory, central processing unit, input/output devices, etc. Server 136 may further be communicably linked to servers 138 and 140 through any wide area network, either public or private, or local area network.

It may be appreciated by one skilled in the art that while only a limited number of computers are depicted, additional computing devices may operate within the system depicted in FIG. 1A, including databases that may be communicably linked to or reside at any of the shown servers.

FIG. 1B is an exemplary diagram of modules included in system environment 100 depicted in FIG. 1A for implementing the principles of the present invention. As shown in FIG. 1B, system 100 includes MWM module 102, automatic trade area module 104, automatic marketing mix module 106, price optimization module 108, consumer focus module 110, which includes high performance parallel query engine 112 and automatic database production module 116. These components will be discussed in detail below.

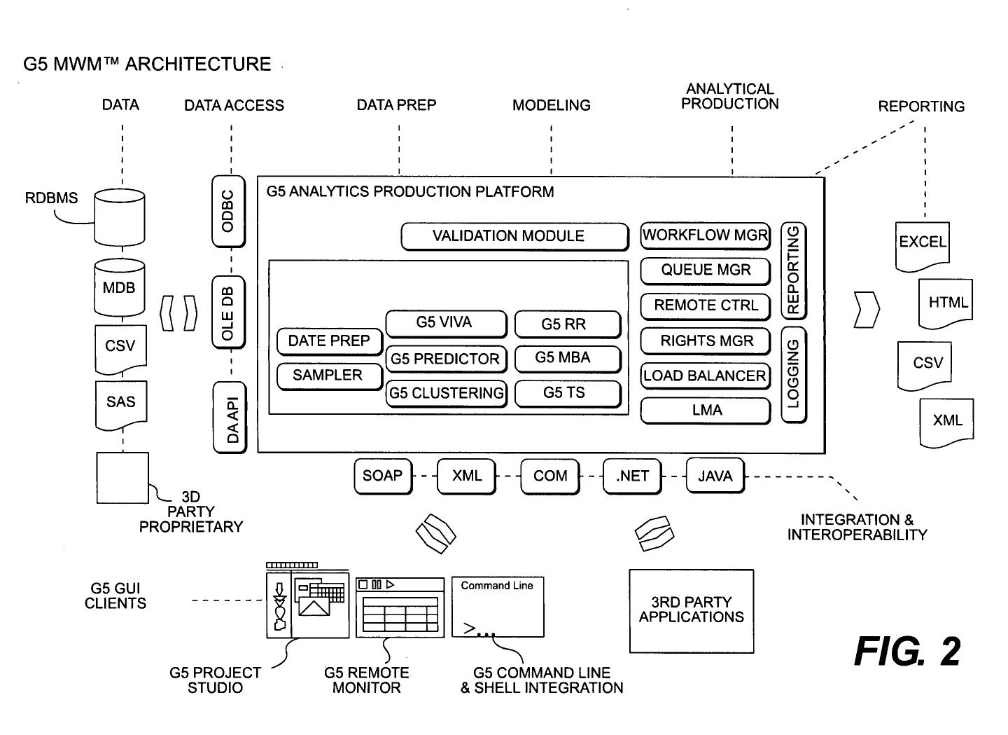

FIG. 2 is an exemplary diagram of a MWM module 102. The components of the MWM module include:

Data Prep=Data Preparation component is responsible for outliers management, pre-processing categorical variables, and discretization.

Sampler is responsible for deriving a sample of the source data. The sample may be used by VIVa module, Clustering module, as well as a standalone module.

G5 VIVa implements Generation 5 Variable Selection Module and is discussed below.

G5 Predictor module implements Generation 5 Automatic Predictive Module and the Prediction Module is discussed below.

G5 Clustering module implements Generation 5 Clustering Module and the clustering module is discussed below.

G5 RR stands for Redundancy Reduction also known as Dimension Redundancy module and is discussed below.

G5 MBA=Generation 5 Market Basket Analysis module.

G5 TS=Generation 5 Time Series module.

Validation Module is responsible for automatic tuning of the prediction procedure and is discussed below.

Workflow Mgr=Workflow Manager component, is responsible for managing process workflow.

Queue Mgr=Queue Manager component is responsible for managing queue of multiple requests.

Remote Control component is responsible for remote (from remote workstation) monitoring and control of the data mining jobs being executed on the server.

Rights Mgr=Rights Manager and responsible for managing user access rights.

Load Balancer is responsible for distributing jobs among available processing units (balancing the load).

LMA stands for Large Memory Allocator, and responsible for memory allocation.

DA API—Data Access API (application programming interface) for accessing data sources that are not compliant to OLEDB and ODBC data access protocols.

OLEDB and ODBC are industry standard data access protocols.

MDB, CSV, SAS are the names of the supported data formats.

RDBMS—relational database management system, can be any OLEDB or ODBC compliant.

System integration is supported via SOAP, XML, COM, NET which are industry-standard system integration protocols and platforms, as well as any NET programming language or Java.

Output formats: XML, HTML, Excel, CSV, etc.

Variable Selection Algorithm (VIVA) Module

Contemporary real world databases are very large and continue to grow. It becomes a real challenge to effectively process such a volume of data within a short period of time. Variable selection is one of the frequently used pre-processing steps in data mining that can help to meet that challenge. The variable selection module removes irrelevant and redundant (“garbage” or noisy) variables and improves performance (time and accuracy) of prediction algorithms. Traditional statistical methods of variable selection (PCA, Factor analysis) are time consuming as each hypothesis must be formulated and tested individually and they require a very good knowledge in statistics in order to use these methods and to understand the results. G5 variable selection approach aims to select, very efficiently, most important variables from the high-dimensional dataset, to automate that process and be of use to people from a wide range of backgrounds.

G5 variable selection algorithm (VIVa) removes all variables that have no chance to be useful in analysis of data. The quality of results is measured by dependency degree measure (conditional weighted Gini index) W(Y/X) that estimates how relevant a given variable subset X is to the target variable Y on given data. This dependency degree measure is closely related to the maximum log-likelihood (or entropy) statistic, but has better geometric properties. VIVa is independent of any adaptive system that can be used for classification or prediction and selects variables on the basis of statistical properties. It belongs to so-called filter methods for variable selection.

The VIVa module performs a stepwise forward and backward search in a set of variables to find a short list of those variables, which have the most significant impact on a target variable. Consider a dataset of n source {X₁,X₂, . . . , Xₙ} and one target Y variables. The VIVa module selects first the variable Xₖ for which the dependency degree measure W(Y/Xₖ) of target variable Y has the highest value. This variable has the most significant impact on target variable. The second most important variable is the variable Xₖ₊₁ whose joint distribution with the previously selected variable has the most significant impact on the target variable Y in the sense of that the joint dependency degree measure W(Y|Xₖ,Xₖ₊₁) attains its maximum value at Xₖ₊₁. Subsequent important variables are selected in the same way, one at a time, maximizing at each step the joint dependency measure of Y on the combined subset of predictors consisting of the previously selected variables and each not yet selected variable. Continuing in this fashion, the algorithm will stop when the difference between dependency degree measures of two sequential iterations will reach some given small number Epsilon. After the algorithm has finished with stepwise forward selection the set of selected explanatory variables will be formed (X₁,X₂, . . . X_{L}). There is possibility that there might be one or more features among the selected which brings superfluity in the sense that excluding this variable from the selected list will not reduce dependency degree measure of target variable on a set of rest of chosen before most important source variables. This possible effect can be eliminated if backward stepwise selection process will be applied. The backward selection process tries to exclude one redundant variable at a time from the variable set selected by the forward selection process. Let {X₁, . . . , X_{L}} be the subset of variables selected by the forward stepwise selection. The algorithm starts with last variable from the list and calculates dependency degree measure W(Y/X₁ . . . X_{L-1}) with L-1 variables (X₁,X₂, . . . ,X_{L-1}). If this value will not be less than dependency degree measure with all variables W(Y/X₁ . . . X_{L}) than feature X_{L} is redundant and can be removed, if not the algorithm checks variable X_{L-1}. This operation is repeated for each of the variable from the set selected by the forward selection process.

VIVa regards all variables as categorical. Variables with continuous values are discretized. G5 developed its own discretizing algorithm. Continues variable is standardized and then new value range is partitioned into 7 bands around the mean.

The feature selection or variables selection module delivers the most important variables, selected from any number of any type of variables that explains the behavior of certain phenomena and enables accurate predictions. The G5 feature selection algorithm improves the performance of data analysis algorithms, also, by limiting the scope of relevant analysis by removing all features, variables that would not be useful in the analysis of data. The selected variables are ranked according to their importance by using joint association index. This association index is an original and very powerful association measure between variables. The association index W(Y|X) estimates the overall degree of dependence of the target feature or dependent variable Y on other features or independent variables X.

The VIVa module is independent of any adaptive system that can be used for classification or prediction. It belongs to filter methods for feature, variable selection. The value of the relevance index, measure of VIVa accuracy, shows high correlation with any specific feature, variable selection methodology. It can handle thousands of any type of variables. In the case of multiple numbers of dependent variables, it can automatically process each of them without user intervention.

Validation Module

The main goal of validation module is to help finding optimal parameters of prediction procedure. It is the method to estimate the prediction error of statistical predictor algorithms. Generation5 validation module implements cross-validation schema. According to this schema, the database (n rows) is randomly divided into K (given number) mutually exclusive subsets (the folds) of roughly the same size (nₖ=n /K). Each subset constitutes a test data to assess the results based on the training data (all remaining subsets) and calculate the prediction error. This process is repeated for each k=1,2, . . . K and then the module combines the K estimates of prediction error. The error measure using by validation module is the Relative Mean Squared Error (RMSE).

To define the optimal parameters of prediction procedure by the Validation module the range of these parameters should be given. Choosing the different values of parameters from the given ranges Validation module calculates the prediction error. The best values of prediction parameters will be the values that give minimum error.

Missing Value Module

This module is used to fill in the blanks or missing values in a database. This can be done as a precursor to further analytics, like modeling or clustering or as a project in itself. The missing values module fills in any missing values by estimating them based on the historic data set.

It is not always necessary to use this module for a project. The prediction module may fill the missing values automatically as part of the prediction process.

For clustering, redundancy, and VIVa, any row with missing values may be ignored.

This algorithm is performed similarly to the algorithm discussed in the automatic prediction module below.

Clustering Module

Clustering is the process of grouping similar items by statistical similarity. The clustering algorithm may employ a K-means clustering algorithm for numerical sources, to group similar customer together into k discrete clusters. K-modes are used for categorical sources and K-prototypes is used for mixed sources.

The groups created are as homogeneous within themselves as possible while being as different from neighboring groups as possible. The idea is to find k appropriate centroids or cluster centers where each customer is assigned to a cluster based on the shortest distance to a cluster centroid.

A number of different schemes of clustering may be performed.

Engineered clusters: This clustering scheme selects clusters that are statistically valid yet close in size to one another (from a marketing point of view this is often more desirable than having one very large cluster and many tiny ones for example).

Statistical clusters—This scheme lets the data determine the format of the clusters and may result in clusters of widely varying size.

Choose Initial Cluster Centers from a file—Use this option when scoring a cluster scheme that you have already developed.

Default maximum number of clusters—The default is Yes, which means the data will drive the number of clusters (we will do this for our example). To specify a range for the number of clusters you wish to create (e.g. you want no more than 4) select “No” and specify a maximum.

Use options in the Output Parameters window under File Information to save the cluster output in CSV, XLS or HTML format or all three.

Once the clustering algorithm is performed, different reports may be generated.

ClusterCenters Report: This details the cluster centroids for each cluster. The centroids are the centre points of each cluster. They are the points from which each observation is evaluated to determine whether it fits into that cluster (recall that cluster assignment looks to see which cluster an observation is closest to). They are also a helpful starting point to understanding the average make-up of each cluster.

ClusterData Report: Displays summary information about the cluster results.

Cluster Distances: This table shows the distance between the cluster centers. This can help determine which clusters are closer together and which clusters are distant. This can be useful if a user wishes to combine certain clusters for practical purposes.

GeneralData: Results of validity index, optimal/maximum number of clusters.

Validity Index: Validity index is a measure of the distance within the clusters divided by the distance between the clusters; it is a measure of the clusters' compactness divided by the clusters' separation.

Optimal number of clusters: This is the number of clusters determined to be optimal based on the clustering scheme you have chosen. In this case, we have three.

Maximum number of clusters: If you specified a maximum, this number will displayed. If not, the module generates a default maximum for your project.

Dimension Reduction for High Dimensional Data

In a data set S, there can be thousands of variables (columns), v₁, v₂, . . . vₙ, and perhaps millions of records (lines). Analyzing with the thousands of variables directly is usually infeasible, very costly, and/or sometimes even less accurate than with just a few variables. Besides, among the thousands of variables, the data types of variables can be mixed: categorical and numerical. Thus reducing the dimensionality of the data set without or with little loss of the information of the data set is of high interest to theory and practice. Here the background and target differences with the VIVa are that there are no target variables, while in VIVa, there are nor more target variables.

The goal of this process is to find a variable subset K of the set L of all variables such that variables not in K is completely determined by those in K, and there are no redundant variables for keeping information complete. This is achieved both theoretically and technically. A subset K is a structure base for the data set S. A cumulative structure explanation percentage information is provided which enables the end user to truncate the list K with little or allowable marginal structural information explanation loss. On the other hand, the reduction report also provides the end user with stair-wise statistical confidence power information.

The technology is association measure-dependence degree on discrete data based, which very efficiently and effectively captures the intrinsic deterministic and stochastic structures in high dimensional data sets.

For those numerical (continuous) variables, this technology requires discreterizing each of them before running dimension reduction procedures. Several automatic discreterizing procedures are available within the system.

When a high dimensional data set is going to be a shared data source base for several or many different analytic prediction projects, for clustering (i.e., business segmentation) or just for a transparent vision of itself, the dimension reduction shows value or power.

The algorithm is similar to that of the VIVA module. Here the artificial target variable is the structure of the whole data set. This artificial target variable is created by identifying maximums of the forward-based cumulative categorical data variance. The whole variable selection process is also following the forward-backward style: forward for choosing most likely candidates for the base K and backward for removing possible redundant candidates from the forward-selected ones to finalize the selection process to get the desired structure base K.

Automatic Predictive Algorithm

A reduction in dimensionality, shrinking the number of variables without loosing the dominant information contained in the database assists in prediction. By narrowing the number of variables without loosing information contained in the database leads to faster data analysis and easier understanding of the database.

The system includes a two-stage dimension reduction algorithm based on unique association measures between variables. This algorithm removes all the variables that have no chance of being useful in the data analysis as well as those that could introduce excessive and counter productive noise. The algorithm retains the minimum number of variables that describe the structure of the whole database without sacrificing information. This algorithm keeps original variables, not their projections and does not request any assumptions of data distribution. Empirical results on both synthetic and real datasets show that dimension redundancy algorithm is able to deal with very large databases with thousands of any type of variables and millions of records.

The system includes several optimal predictive models for automatically handling various situations with static data sets. These predictive models uses nearest neighbors methodology. The sizes of neighborhoods are determined by cross-validation optimization. The following is a description of the prediction algorithm for static data in 2D table for records (or units) by variables (or fields), which is especially powerful in handling high dimensional large data sets.

When data is high dimensional, after the data has been prepared, VIVa has been processed for variable selection, dimension reduction occurs to finalize predictor selection for prediction: this is an automatic stopping step solution, which handles the balancing between dependence degree and confidence power. A categoricalized profiling data set S₀ is provided which reflects results from global to local strategy and only carries the target variable and finally selected predictors.

When the source (independent) variables in the data set are all categorical the prediction is based on conditional mode, conditional median and conditional expectation corresponding to the possible nominal, ordinal or numerical type of the target (dependent) variable.

When the source (independent) variables in the data set S_{θ} is interval scaled, the local volatility and global trend balanced approach to predict the target variable is used, in which a statistical distance based on the principal component analysis for data transformation and then variance contribution proportion weights is used for handling local volatility and regression for the global trend. Associated with the local and global balancing, there is a setting for local and global weights. The setting is based on how far away of the relation between the source variables and target variable from liner or nonlinear dependence is.

When the source (independent) variables in the data set are mixed (categorical and numerical, categorical variables are transferred to numerical and the prediction is based on conditional mode, conditional median corresponding to the possible nominal or ordinal type of the target (dependent) variable. In the case when target variable is numerical the local volatility and global trend balanced approach to predict the target variable is applied.

G5 Price Optimization Module 108

The purpose of the G5 Price Optimization Module is an automatic solution to the challenge of optimizing the price to maximize return. The price optimization problem consists in determining the price at which each unit of a good must be sold in order to maximize returns from sales. The module can be used both to identify the optimal price within a user specified interval, and to estimate the marginal change in return per unit change in sale price from a given base price.

The module presents a form (Settings) in which the user enters: the location of the file with observed cases (input file); the location(s) of project working/output files; a request (yes/no) to estimate a confidence band for the results and a formula to compute the cost of producing y units: C(y).

The user moves to a Variable Selector tab. The module queries the input file selected in the previous step, and presents the user with the list of variables in the file. The user defines: Target variable (number of units sold); Price variable and variables describing general market conditions

The user moves into a Input tab. The module queries the file and presents an interface with the list of variables selected on Variable Selector tab and summary information on those variables.

The user defines analytical options with respect to: lower and upper bounds for the region were the price is to be varied and a particular value of the price at which to compute the elasticity of return.

The user enters the cost per unit when y units are produced; this requires the definition of a function C(y). General piece-wise constant functions is allowed, i.e.: a function that can be written in the form:

$$unit cost when y units are produced = \{ \begin{matrix}{c}_{0} & if y \leq {a}_{0} \\ {c}_{1} & if {a}_{0} < y \leq {a}_{1} \\ … & \\ {c}_{L} & if {a}_{L} < y\end{matrix}$$

The user enters the cost of producing y units; this requires the definition of a function C(y). general piece-wise polynomial functions are allowed, i.e.: a function that can be written in the form: C(y)=(y≦a₁)P₀(y)+(a₁<y≦a₂)P₁(y)+ . . . +(aₖ<y)Pₖ(y) where P₁, . . . , Pₖ are polynomials.

The user activates the analysis using a Run icon. The module returns prediction of expected returns for prices according to the analytical options set as discussed below.

The user moves to a Report tab. The output report contains statistics for a sequence of prices in the range selected by the user: estimate of expected target (sales/profit etc.); the price within the range supplied by the user at which the expected return is maximized, and the corresponding expected return; and the elasticity of return with respect to price at a price level supplied by the user.

The user moves to a Graph tab. The Graph tab presents the scatter-plot of prices within the range supplied by the user and expected returns.

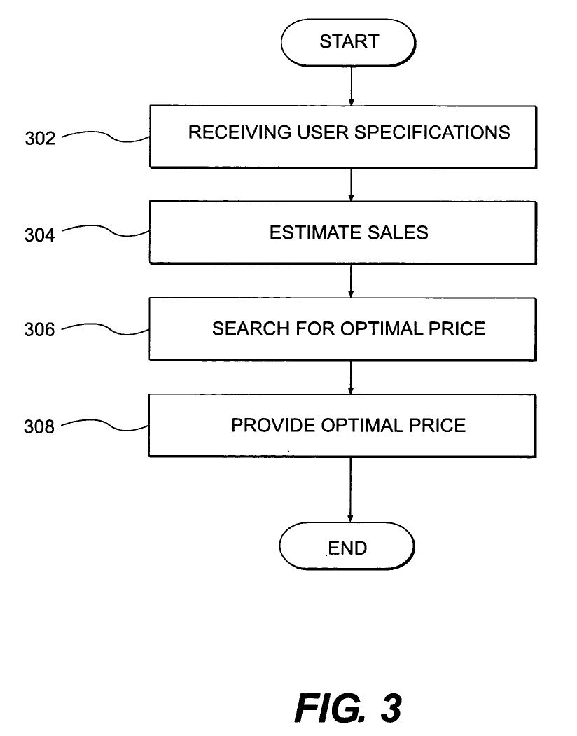

FIG. 3 depicts an exemplary flow diagram of the steps performed in determining optimal price. The method consists of taking the user specifications (Step 302) and automatically generating a file containing descriptions of a plurality of scenarios covering the price(s) supplied by the user. For each scenario and price, sales are estimated on the basis of the patterns in the observed cases (Step 304). A search of the optimal price is carried either by inspections of all scenarios, or by a random search on a sample of scenarios, or by numerical optimization of the price function, or by a combination of a random preliminary search followed by numerical optimization (Step 306). The determined optimal price is then provided to the user (Step 308).

The method estimates the values of the sales without resorting to selecting a predictor from a finite dimensional family of predictors. The method obtains non-parametric predictions as produced by Generation 5 MWM predictive module.

The present method obtains an estimate of expected sales for a given price by averaging predicted sales values at a sample of general market conditions. At the user's request, confidence bands for prediction are computed by re-sampling.

User Interface Parameters:

Variables: list of variables about general market conditions: x₁, . . . , x_{d}; unit price: p; number of units sold: y.

Domain of variables: lower and upper bounds of the region where the price is to vary: L: lower bound for p; U: upper bound for p.

increments: Δp: non-negative increment for p

Other parameters: price at which elasticity of return is requested: p₀; request to estimate a confidence band: CB; formula to compute the cost of selling (producing and distributing) y units: C(y)

The module carries multiple tasks. First, a file A is generated with values: L+u Δp with u=0, 1, . . . , integer part of ((U−L)/Δp).

A sample S of values of (x₁, . . . , X_{d}) is drawn from the file with observed cases. The value of the y is predicted for each price in A and each sample scenario in S. Predictions are obtained using Generation 5 MWM prediction methodology as reported elsewhere. For an element x in S and a price p in A, we let ŷ(x, p) denote the predicted value of y at (x,p).

For each element p of A, the expected number of units sold when the unit price is p is estimated as:

$$y * ( p ) = \frac{1}{\vert S \vert} {\sum }_{x ∈ S}^{} \hat{y} ( x , p )$$

and the return is estimated as: R(p)=p y*(p)−C(7y*(p)).

The next step is to maximize R in A; the price p in A at which R attains its maximum as well as the maximum estimated value R(p) are included in the report.

If the user requests the computation of confidence bands, then step 2-5 are repeated several times. Confidence bands are reported back.

If the user request the computation of return elasticity at a price p₀, then the derivative

$$\frac{ⅆ R}{ⅆ p} ( {p}_{0} )$$

is estimated using first order non-parametric regression as implemented in the G5 prediction module, and the elasticity of R is computed as: R′(p₀)/R(P₀). The value of the elasticity is reported.

Automatic Trade Area Module 104

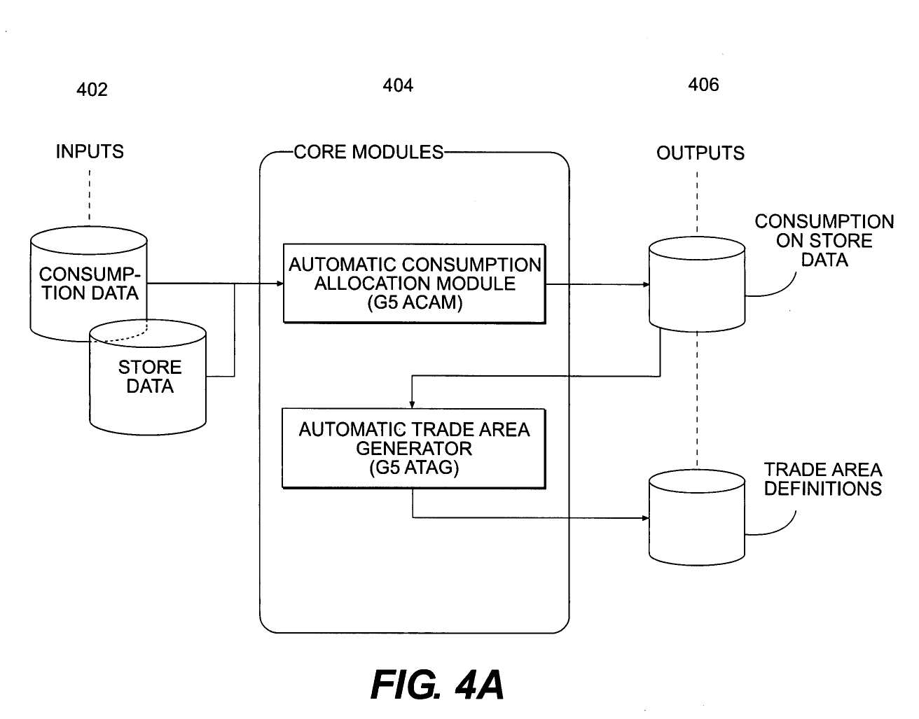

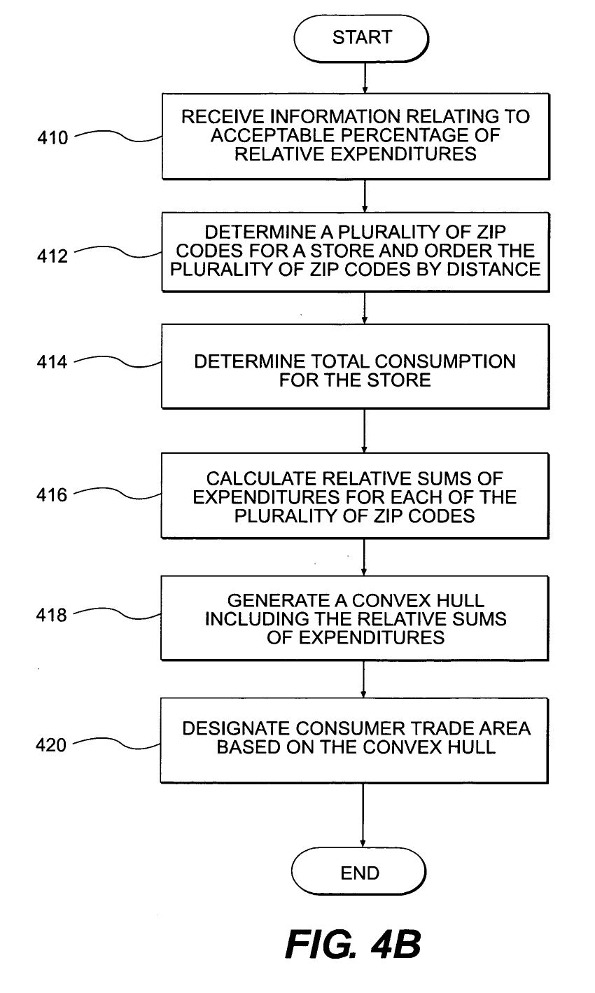

FIG. 4A depicts an exemplary diagram of the automatic trade area module. As shown in FIG. 4A, inputs 402 include consumption data and store data. Core modules 404 include automatic consumption allocation module and automatic trade area generator. Output 406 includes consumption by store data and trade area definitions.

G5 Automatic Trade Area Module is an automatic solution to the challenge of creating store trade areas (by product). Output from G5 Automatic Trade Area Module can be visualized with G5 Consumer Focus reporting tools.

Software Structure: The software is composed of 2 modules that correspond to the steps in trade area creation and utilization: Automatic Consumption Allocation Module and Automatic Trade Area Generator 402.

Automatic Consumption Allocation Module

The Consumption Module describes distribution of product consumption/expenditure across any given geography at the level of Postal Code (Canada)/Zip+4 (US). Data are created using observational data that contains postal code or zip+4 information and consumption/expenditure information.

The Consumption Module requires the following input Data Sources:

Consumption Model data (Zip+4GZIP9 level:Zip+4); Number of Households; Household Expenditure ($) for every product of interest; Zip+4 Longitude and Zip+4 Latitude.

List of Stores (example: Trade Dimensions Database of TDLinx®); Total Store Sales; Store Longitude; Store Latitude

In order to distribute the household consumption (expenditure) of the analyzed product(s) among all stores patronized by the household (residing within a limited pre-defined distance of a store), G5 has developed G5 Store Attractiveness Model.

Based on the G5 Store Attractiveness Model, the Attractiveness Coefficient C of each store S to a households H located in a particular Zip+4 is positively associated with the total store sales and negatively associated to the distance between the Zip+4 and the store.

The relative proportion of total household consumption (expenditure) of the analyzed product(s) associated with a specific store is represented by a Scale Factor, which is proportionate to the Attractiveness Coefficient (within the set of stores that are not farther then pre-defined maximum distance from the Zip+4).

The Automatic Trade Area Generator requires the following data sets
i) : Data Input: Zip+4 information; Di: Household Expenditure in i-th store; Fᵢ: Scale Factor (proportion of Household Expenditure associated with i-th store); Zip+4 Longitude; Zip+4 Latitude; Zip+4 Expenditure in the product under consideration.
ii) List of Stores (example: Trade Dimensions Database of TDLinx®): Store ID; Total Store Sales; Store Longitude and Store Latitude.

User-defined options: The interface allows for the user-define choice of: Trade Area Type (Circle, Polygon etc.); minimum percentage of Zip+4 Consumption Coverage accounted for within the store trade areas; :and Rₘₐₓ Maximum Distance of Zip+4 to store.

Software requirements: Geographical Mapping Application (MapInfo or equivalent).

FIG. 4B depicts an exemplary flow diagram of the steps performed by the automatic trade area module. As shown in FIG. 4B, the module receiving information relating to acceptable percentage of relative expenditures (Step 410).

Trade Area Method 1 (% of Consumption Coverage): The Zip+4′ serviced by Gzip9s for a particular store are extracted from the input table with Zip+4 consumption distributed among stores; the extracted Zip+4's are sorted according to their distances to the store (Step 412). Total consumption at the store is computed (Step 414). Cumulative relative sums of expenditures are computed for the Zip+4's (Step 416). The set of Zip+4's with cumulative relative expenditures less than or equal to the “User Selected percentage” are selected; the convex hull of the selected Zip+4 is drawn (Step 418). If it is important that the trade area region exclude Zip+4's that are not serviced by the store, then Thiessen polygons for all Zip+4's within the convex hull must be created, and those polygons belonging to Zip+4's that are serviced by the store are merged to form the final region (Step 420).

Trade Area Method 2: The Zip+4's serviced by Gzip9s a particular store are extracted from the input table with Zip+4 consumption distributed among stores. These points are processed by a triangulator program to be assigned a “shell” ID, which is used as a proxy for the distance from the boundary of the convex hull of the set of points. The set of points that encloses all the others [not necessarily the convex hull] is considered the first “shell”. If these are removed, another “shell” can be created, and so on until all points are assigned a shell ID. The Zip+4's are assigned a scale factor, based on shell ID, ranging from 0.01 for the outermost shell to 1.0 for the innermost. This means that the outermost points are less “important” than the innermost points, which is required for the assumption that Zip+4's are more likely to be in the target area TA if they are closer to the interior of the region. The Zip+4's are assigned another scale factor based on distance to the store, ranging from 0.01 for the farthest Zip+4 to 1.0 for the nearest. This also matches the above assumption. A “scaled consumption” factor, which is the product (Shell ID Scale Factor)*(Distance Scale Factor)*(Consumption Value) is computed. This weights the Zip+4Gzip9-level consumption value by distance and by distance from the boundary. The table is sorted by the scaled consumption factor descending, i.e. from largest to smallest. As in the previous model, the cumulative relative consumption is computed and all Zip+4's with values less than or equal to “User Selected %” are selected and a convex hull is drawn around them. If it is important that the trade area region exclude Zip+4's that are not serviced by the store, then Thiessen polygons for all Zip+4's within the convex hull must be created, and those polygons belonging to Zip+4's that are serviced by the store are merged to form the final region.

Consumer Focus Module 110

G5 ConsumerFocus is a high-performance automatic reporting system that provides variety of reports including but not limited to consumer behavior, consumer marketing, trade marketing. It is designed to work with large volume low level of geography (ZIP+4) demographic and consumption data.

Functionality: Store Trade Area demographic, socio-economic, financial behavior, and lifestyle summaries; Store Trade Area consumption summaries, by product; Comparative Analysis summaries; Market potential estimation summaries; Store Trade Area summaries by segment and Mapping.

Productivity Features include: Scalable, high performance automatic parallel query engine for large volume zip+4 data; Reach and customizable Web-based UI, providing intuitive support of end-user workflow; Graphical visualization of results—tabular, form, charts, maps and Raw data extraction.

High Performance Automatic Parallel Query Engine 112

Consumer Focus Module includes a high performance automatic parallel query engine. The query engine includes a report request page, a report preparation module, a report status page, a SQL load balancing module, a cross-report data cache, a selection criterion data cache module and a report cache module.

The report request page enables a user to request a report. The request is received through a web application. If the report is in the cache, it is added to the list of reports as completed with a link to the cached report location. If the report is not in the cache report, the report request is created and execution is started as a separate thread. The user is redirected to the report status page.

The report preparation module maintains a list of running and completed report requests. Each report request issues queries to retrieve data, creates an HTML report and pictures, adds the report to the cache and marks the report as complete.

The SQL load balancing module receives queries and executes them on a SQL server with a shortest queue. If all SQL servers have large queues, the SQL query is put into a pending queue. The load balancing module subscribes to event of execution completion. On this event, the load balancing module removes the query from SQL server queue and notifies SQL executor that the query was finished. If the pending query queue is not empty, the load balancing module gets the request from it and sends it to the SQL server for execution.

The cross-report data cache caches other cross report data, other than the selection identification data.

The selection criterion data cache module accepts requests to select low level data ids (for example, zip+4) provided as selection criterion; checks against cached criterion data if there is already data) previously selected; if yes, the id for this data is returned; if not, selection query is executed, the data is saved in cache and its id is returned.

The report cache module provides report data by report type and selection criteria.

The report status page returns all reports in the list of reports.

Automatic Marketing Mix Module 106

G5 Marketing Mix Module is an automatic solution to the challenge of optimizing the distribution of marketing funds across various marketing channels.

G5 Marketing Mix User Value: G5 Marketing Mix Module allows a user to: Predict Total sales generated through a specific distribution of marketing funds across various marketing channels; to evaluate Incremental impact of a single marketing channel investment onto sales/profit (G5 Marketing Mix defines profit as total sales net of total marketing investment); Incremental impact of multiple marketing channels investment onto sales/profit; Total/Incremental ROI corresponding to a specific distribution of marketing funds across various marketing channels and Long term effect of market actions onto sales/profits; and optimize marketing investment, by channel and Return on Investment.

The module has the flexibility to take into consideration user's constraints with respect to total available marketing budget and acceptable total/incremental ROI.

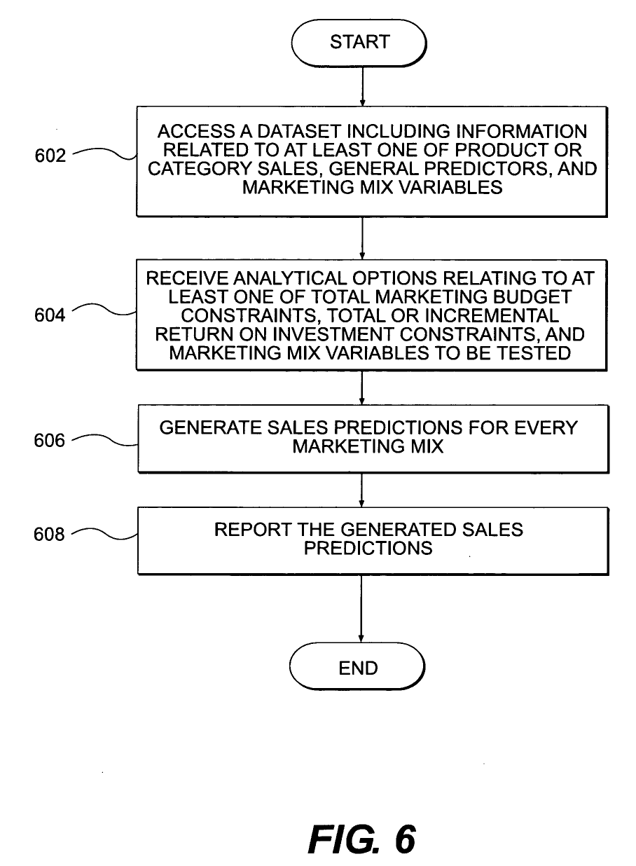

FIG. 6 depicts an exemplary flow diagram of the steps performed by the marketing mix module.

G5 Marketing Mix User Guide Settings/Input Tabs_Step 1: A user brings into G5 Marketing Mix a training dataset with historical cases that contains information:
i) Product/Category Sales;
ii) “General Predictors: predictors that affect sales over which the user has no control, e.g.: ” (a set of market and/or company related variables selected by G5 MWM VIVa as the predictors of Product/Category Sales, such as “Advertising Investment by Competitor”, weather conditions, etc.

)“Marketing Mix” variables: sales predictors whose values can be controlled by the user, and whose optimal value is sought (e.g.: National Radio Advertising Spent, Local TV Add Spend, Internet Add Spend, etc.) (FIG. 6; Step 602)

Step 2: A user defines analytical options with respect to:
i) Constraints: Total Marketing Budget constraints; Total/Incremental ROI constraints and Marketing Mix variables to be tested in the analysis.

Value Ranges (Defined as minimum value, maximum value, and step size. For user reference, historical information statistics are available): The range of potential investments, by marketing channel and the range of potential “General Predictors” values. (FIG. 6; Step 604)

Step 3: Activate the analysis using Run icon.

The module builds Sales prediction for every single Marketing Mix defined in analytical options of Step 2 (FIG. 6; Step 606). The module carries multiple tasks. First, a file A is generated by sampling the training cases, with scenarios defined by (g, m), where g is an array of values of the “General Predictors”, m is an array of values of the “Marketing Mix” predictors, and the scenario (g,m) satisfies budget constraints. Second, an estimate Y(g,m) of sales under scenario (g,m) is obtained using Generation5 Automatic Predictive Module. Third, the sales under “Market Mix” values m is estimated by averaging Y(g,m) over all values (in the sample) of the “General Predictor” as

$$Y * ( m ) = \frac{1}{\vert S \vert} {\sum }_{g ∈ S}^{} y ( g , m ) .$$

Fourth, the value m that maximizes Y* is found. For small data sets, all values of m in a fine grid are inspected; for large datasets, the maximum of Y* is obtained by numerical maximization.

Report Tab: The report tab presents the Marketing Mix optimization results (FIG. 6; Step 608). For each level of total marketing investment (within the total Budget/ROI constraints), it returns: an estimate of the maximum possible level of sales/profit; an estimate of the best combination of marketing investment, by channel and Total and incremental marketing ROI.

Graph Tab: Bar chart that for each level of total marketing investment (within the total Budget ROI constraints) graphically presents: The best combination of marketing investment, by channel and the maximum possible level of sales.

Additionally, the Automatic marketing mix module provides the ability to optimize Marketing Mix within budget constraint by channel (in addition to total budget constraint); Ability to work with Marketing Mix variables expressed in units other than dollars (number of spots, time, number of exposures, # of impressions, etc.) and apply cost per unit information for Marketing Mix optimization and Enhanced reporting (visual/tabular).

Automatic Database Production on Postal Code, Zip+4 level Module 116

Database Production on Postal Code/ZIP+4 level is method for building databases of estimated data at a granular level, herein represented by a postal code or a Zip+4, using a mixture of source data at a lower granular level, herein represented by a household, at the same granular level, and at an aggregated level, herein represented by census dissemination areas. Database Production on Postal Code/ZIP+4 level is carried in 3 steps.

i) Step 1. Creation of Geographical Linkage: PC [symbol] DA/Zip+4 [symbol] Block Source Data for Step 1:
a) Postal code (Zip+4) location file;
b) Census DA (Block) boundary file
c) Street network file.
The linkage file describes the connection between granular level units (e.g.: postal units) and aggregated level units (e.g.: census units).

ii) Step 2. Creation of training cases dataset and “anchor” variables on target cases at the PC/ZIP+4 level
Data Units:
   a) Training cases (“historical Data”): Households
   b) Target cases (“Target Data”): PC/ZIP+4
Variables:
   a) Dependent Variables: variables whose values are to be predicted on the target cases;
   b) Independent Variables:
      a. Base unit source data: PC/ZIP+4 level:
      b. Business or residential indicator;
      c. Number of Dwellings;
      d. Number of Dwellings by type;
      e. Other: e.g.: home ownership, credit data;
      f. Demographical source data (DA/Block level)
      g. Census data from Statistics Canada (US Census Bureau).
         The data for the training cases consists of a mixture of data at a more detailed level (household) than the one sought (postal code), the same granular level (postal code), and an aggregated level (Dissemination Area or Census Block); the linkage file is used to append aggregated data to the units at the granular level.

The following table represents the various data sets as flat files. The “Predicting” represents the part containing predicted values.

| ID | Dwelling | Credit Data | Census Data | Dependent Variables |
|---|---|---|---|---|
| Table-ID | TYPE | CDV01 . . . CDV20 | CCV01 . . . CCV30 | VarY001 . . . VarY800 |

| | | |
|---|---|---|
| HST00001 | Known | Known |
| . . . | | |
| . . . | | |
| HST99999 | | |
| TG000001 | Known | Predicting |
| . . . | | |
| . . . | | |
| TG999999 | | |

iii) Step 3. Database production using PC/ZIP+4 level
Data Units:
   a. Historical Data: PC/ZIP+4
   b. Target Data: PC/ZIP+4
Variables:
   a) Dependent Variables: Any dataset that includes PC/ZIP+4 information.
   b) Independent Variables: Anchor Variables created in Step 2

The following table represents the various data sets as flat files. The “Predicting” represents the part containing predicted values.

| Note | ID | Anchor Variables | Dependent Variables |
|---|---|---|---|
| Variable | Table-ID | ACV01 . . . ACV99 | VarY001 . . . VarY800 |
| Name | | | |
| Historical Part | HST00001 | Known | Known |
| | . . . | | |
| | . . . | | |
| | HST99999 | | |
| Target Part | TG000001 | Known | Predicting |
| | . . . | | |
| | . . . | | |
| | TG999999 | | |

Database Production is done using Generation5 MWM module: independent variables selection is done by the VIVa Module or the Dimension Reduction Module; predictions are obtained by means of Generation 5 Predictive Module.

Independent Variables Selection: The choice of anchor variables for a specific predicted variable can be done using either the VIVa Module or Dimension Reduction Module. In order to simultaneously predict a number of dependant variables, anchor variables can be selected without consideration of the predicted variables using Dimension Reduction Module.

Prediction: predicted values obtained through Generation 5 Predictive Algorithm as described above.

Conclusion

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or hardware alone.

Additionally, although aspects of the present invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A method for optimizing price of a good to maximize returns from sales, comprising:
receiving user specifications and automatically generating a file containing descriptions of a plurality of scenarios covering at least one price supplied by the user;
for each scenario and price, estimating sales on the basis of patterns in observed cases;
searching for an optimal price by one of 1) inspections of all scenarios, 2) by a random search on a sample of scenarios, 3) by numerical optimization of a price function; and 4) a combination of a random preliminary search followed by numerical optimization; and
providing the optimal price based on the search.

2. The method of claim 1, wherein the estimate of expected sales for at least one price is determined by averaging predicted sales values at a sample of general market conditions.

3. The method of claim 2, wherein confidence bands for prediction may be computed by re-sampling.

4. An apparatus for optimizing price of a good to maximize returns from sales, comprising:
a memory storing a set of instructions; and
a processor executing the stored set of instructions to perform a method including:
receiving user specifications and automatically generating a file containing descriptions of a plurality of scenarios covering at least one price supplied by the user;
for each scenario and price, estimating sales on the basis of patterns in observed cases;
searching for an optimal price by one of 1)inspections of all scenarios, 2) by a random search on a sample of scenarios, 3) by numerical optimization of a price function; and 4) a combination of a random preliminary search followed by numerical optimization; and
providing the optimal price based on the search.

5. The apparatus of claim 4, wherein the estimate of expected sales for at least one price is determined by averaging predicted sales values at a sample of general market conditions.

6. The apparatus of claim 5, wherein confidence bands for prediction may be computed by re-sampling.

7. A method for determining consumer trade areas comprising:
receiving information related to an acceptable percentage of relative expenditures;
determining a plurality of zip codes for a store and order the plurality of zip codes by distance;
determining total consumption for the store;
calculating relative sums of expenditures for each of the plurality of zip codes;
generating a convex hull including the relative sums of expenditures based on the received information relating to the acceptable percentage of relative expenditures; and
designating a consumer trade area based on the generated convex hull.

8. An apparatus for determining consumer trade areas comprising:
a memory storing a set of instructions; and
a processor executing the stored set of instructions to perform a method including:
receiving information related to an acceptable percentage of relative expenditures;
determining a plurality of zip codes for a store and order the plurality of zip codes by distance;
determining total consumption for the store;
calculating relative sums of expenditures for each of the plurality of zip codes;
generating a convex hull including the relative sums of expenditures based on the received information relating to the acceptable percentage of relative expenditures; and
designating a consumer trade area based on the generated convex hull.

9. A method for optimizing the distribution of marketing funds across various marketing channels, comprising:
accessing a dataset including information related to at least one of product or category sales, general predictors, and marketing mix variables;
receiving analytical options relating to at least one of total marketing budget constraints, total or incremental return on investment constraints, and marketing mix variables to be tested;
generating sales predictions for every marketing mix; and
reporting the generated sales predictions.

10. An apparatus for optimizing the distribution of marketing funds across various marketing channels, comprising:
a memory storing a set of instructions; and
a processor executing the stored set of instructions to perform a method including:
accessing a dataset including information related to at least one of product or category sales, general predictors, and marketing mix variables;
receiving analytical options relating to at least one of total marketing budget constraints, total or incremental return on investment constraints, and marketing mix variables to be tested;
generating sales predictions for every marketing mix; and
reporting the generated sales predictions.

11. A method for load balancing a plurality of queries, comprising:
receiving a query for processing at a load balancing module;
identifying one of a plurality of servers capable of processing the received query by analyzing a queue of pending queries each of the plurality of servers;
sending the received query to the identified server for processing;
determining that the received query was processed; and
reporting the results of the processed query.

12. The method of claim 11, wherein if all of the plurality of servers have a full queue of pending queries, the load balancing module stores the received query until the pending queue of one of the plurality of servers is capable of receiving the query.

13. An apparatus for load balancing a plurality of queries, comprising:
a memory storing a set of instructions; and
a processor executing the stored set of instructions to perform a method including:
receiving a query for processing;
identifying one of a plurality of servers capable of processing the received query by analyzing a queue of pending queries each of the plurality of servers;
sending the received query to the identified server for processing;
determining that the received query was processed; and
reporting the results of the processed query.

14. The apparatus of claim 13, wherein if all of the plurality of servers have a full queue of pending queries, the load balancing module stores the received query until the pending queue of one of the plurality of servers is capable of receiving the query.

15. A method for producing a database based on postal code, comprising:
creating a geographical linkage representing a connection between granular level units and aggregated level units;
creating a historical cases dataset and anchor variables on target cases; and
producing a database by using the geographical linkage and historical cases dataset to predict a target dataset.
